(19) United States
(12) Patent Application Publication
(10) Pub. No.: US 2022/0161439 A1
(43) Pub. Date: May 26, 2022

(54) INFORMATION PROCESSING APPARATUS, INFORMATION PROCESSING METHOD, ROBOT SYSTEM, MEASUREMENT SYSTEM, METHOD OF MANUFACTURING ARTICLE WITH ROBOT SYSTEM, AND RECORDING MEDIUM

(71) Applicant: CANON KABUSHIKI KAISHA, Tokyo (JP)

(72) Inventor: Tomohiro Izumi, Kanagawa (JP)

(21) Appl. No.: 17/529,144

(22) Filed: Nov. 17, 2021

(30) Foreign Application Priority Data
Nov. 26, 2020 (JP) 2020-196002

(51) Int. Cl. B25J 9/16

(52) U.S. Cl. CPC B25J 9/1697; B25J 9/1664

(57) ABSTRACT

An information processing apparatus includes one or more processors configured to execute measurement of a position of a predetermined part of a robot apparatus including a joint having a transmission mechanism and calibration of the robot apparatus, wherein the measurement and the calibration are executed in response to a predetermined operation.

### BACKGROUND

### Field of the Disclosure

The present disclosure relates to information processing.

### Description of the Related Art

In recent years, a robot apparatus including a robot arm and an end effector has been widely used for labor saving at production sites and automation of production equipment in a factory or the like. Such a robot arm moves, depending on work to be executed, its end effector along a target trajectory, but an actual trajectory of the end effector deviates from the target trajectory, inevitably. Examples of factors in the deviation include an assembly error at the time of manufacture of the robot arm and a periodic error due to a transmission mechanism used in each joint of the robot arm. The assembly error is an error that occurs due to attachment of each mechanism in a state slightly misaligned from a designed value at the time of manufacture of the robot arm, and accumulated errors appear as a positional error in the end effector. The periodic error is an error that is piled up periodically on an angle of rotation of an output shaft of the transmission mechanism in synchronization with an angle of rotation of an input shaft of the transmission mechanism, and is also referred to as an angular transmission error. The assembly error in the robot arm and the angular transmission error in the transmission mechanism are main error factors affecting the target position of the end effector.

Japanese Patent Application Laid-Open No. 2020-93363 discusses a method of reducing deviation in joint angle due to the angular transmission error in a transmission mechanism and then calibrating a robot apparatus to reduce misalignment of an end effector due to the assembly error in a robot arm. In other words, robot calibration is executed in a state where the error due to the angular transmission error in the transmission mechanism is minimized in advance to achieve a more accurate calibration for reduction of an influence of the assembly error.

### SUMMARY

According to embodiments of the present disclosure, an information processing apparatus includes one or more processors configured to execute measurement of a position of a predetermined part of a robot apparatus including a joint having a transmission mechanism and calibration of the robot apparatus, wherein the measurement and the calibration are executed in response to a predetermined operation.

Further features of the present disclosure will become apparent from the following description of exemplary embodiments with reference to the attached drawings.

### BRIEF DESCRIPTION OF THE DRAWINGS

FIG. 1 is a schematic diagram illustrating a robot system according to an exemplary embodiment.

FIG. 2 is a diagram illustrating a joint in a robot arm body according to the exemplary embodiment.

FIG. 3 is a block diagram illustrating a control system of the robot system according to the exemplary embodiment.

FIG. 4 is a schematic diagram illustrating coordinate systems in the robot arm body according to the exemplary embodiment.

FIGS. 5A and 5B are tables for parameters as calibration targets according to the exemplary embodiment.

FIG. 6 is a schematic diagram illustrating a measurement system for calibration of the robot arm body according to the exemplary embodiment.

FIGS. 7A to 7C are diagrams each illustrating an interface in calibration of the robot arm body according to the exemplary embodiment.

FIG. 8 is a flowchart illustrating a calibration method according to the exemplary embodiment.

FIG. 9 is a schematic diagram illustrating a measurement-range cube indicating a setting range of measurement points for calibration according to the exemplary embodiment.

FIG. 10 is a flowchart illustrating setting of a measurement point according to the exemplary embodiment.

FIG. 11 is a flowchart illustrating setting of an additional measurement point according to the exemplary embodiment.

FIGS. 12A and 12B are a three-dimensional scatter diagram of measurement points and a three-dimensional scatter diagram of additional measurement points, respectively, according to the exemplary embodiment.

FIG. 13 is a graph illustrating comparison between error evaluation results before and after calibration according to the exemplary embodiment.

### DESCRIPTION OF THE EMBODIMENTS

The method discussed in Japanese Patent Application Laid-Open No. 2020-93363 is based on the premise that the characteristic of the angular transmission error in the transmission mechanism is known. In general, the individual transmission mechanisms have different angular transmission error characteristics. To examine each characteristic, identification based on real-machine operation results is thus required. For example, in a predetermined operation of the robot apparatus, an input shaft angle and an output shaft angle of the transmission mechanism in each joint are each measured, for example, by a rotary encoder or an inertial sensor. Then, the characteristic of the angular transmission error is estimated from measurement results thereof. Thus, the technology in Japanese Patent Application Laid-Open No. 2020-93363 requires that the characteristic of the angular transmission error in each transmission mechanism and the assembly error in the robot arm be measured separately. Thus, calibration of the robot apparatus is time-consuming and is intricate to an operator.

Embodiments of the present disclosure are directed to enabling an operator to calibrate a robot apparatus easily.

An exemplary embodiment of the present disclosure will be described below with reference to the accompanying drawings. The following exemplary embodiment is merely an example and thus, for example, those skilled in the art can appropriately make alterations in detailed configuration without departing from the scope of the spirit of the present disclosure.

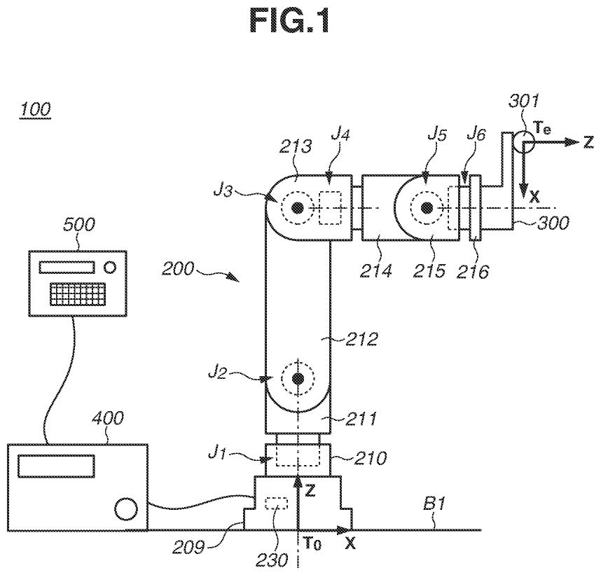

FIG. 1 is a schematic diagram illustrating a robot system 100 according to a first exemplary embodiment. As illustrated in FIG. 1, the robot system 100 includes a robot arm body 200, an end effector body 300, a control apparatus 400 that controls the robot arm body 200 and the end effector body 300, and an external input apparatus 500.

The robot system 100 is provided in a manufacturing line and is used for manufacture of an article.

For example, the article is manufactured through processing in which the robot arm body 200 brings a predetermined workpiece grasped by the end effector body 300 into contact with another workpiece to combine the workpieces. Examples of materials of the article include the predetermined workpiece and the other workpiece. Examples of other pieces of work to be executed include conveyance, assembly, machining, and application. Examples of pieces of machining include cutting, grinding, polishing, and sealing.

An and effector suitable for work is attached to the robot arm body 200.

The robot arm body 200 according to the present exemplary embodiment is a vertical articulated robot arm mounted on a pedestal B1. The robot arm body 200 includes a plurality of joints J₁ to J₆, a base 209, and a plurality of links 210 to 216. The plurality of links 210 to 216 is coupled in this order in series via the plurality of joints J₁ to J₆. More specifically, the first joint J₁, second joint J₂, third joint J₃, fourth joint J₄, fifth joint J₅, and sixth joint J₆ are located from a side on which a base end of the robot arm body 200 is located (a side on which the link 210 is located) to a side on which a leading end thereof is located (a side on which the link 216 is located). The link 210 being a base end portion of the robot arm body 200 is fixed to the base 209. The base 209 is fixed to an upper surface of the pedestal B1. The links 211 to 216 are rotary-driven by the joints J₁ to J₆, respectively. Thus, the robot arm body 200 can adjust the end effector body 300 to any position and any posture in triaxial directions.

The end effector body 300 being an example of a predetermined part that the robot arm body 200 operates is provided at the link 216 being a leading end portion of the robot arm body 200. More specifically, the link 216 serves as a holder that holds the end effector body 300. In the present exemplary embodiment, an example will be described where a three-dimensional measurement jig including the end effector body 300 including, at its leading end, a retroreflector 301 that retro-reflects a laser beam.

The posture of the robot arm body 200 can be expressed by a coordinate system. A coordinate system T₀ in FIG. 1 is set to the pedestal B1 to which the robot arm body 200 is fixed. A coordinate system T₀ is set to the end effector body 300. The coordinate system Tₑ indicates a tool center position (TCP).

In the present exemplary embodiment, the coordinate system Tₑ is set to the retroreflector 301 of the end effector body 300. The coordinate system T₀ and the coordinate system Tₑ are each expressed by three axes of XYZ. For more sensitive detection of a positional error of Tₑ due to an angular transmission error in the sixth joint J₆, the coordinate system Tₑ is arranged at a predetermined distance from the rotational axis of the sixth joint J₆.

The control apparatus 400 can control the posture of the robot arm body 200. The control apparatus 400 is connected with the external input apparatus 500. For example, the external input apparatus 500 is a teach pendant and is used by an operator to teach the robot arm body 200 to operate.

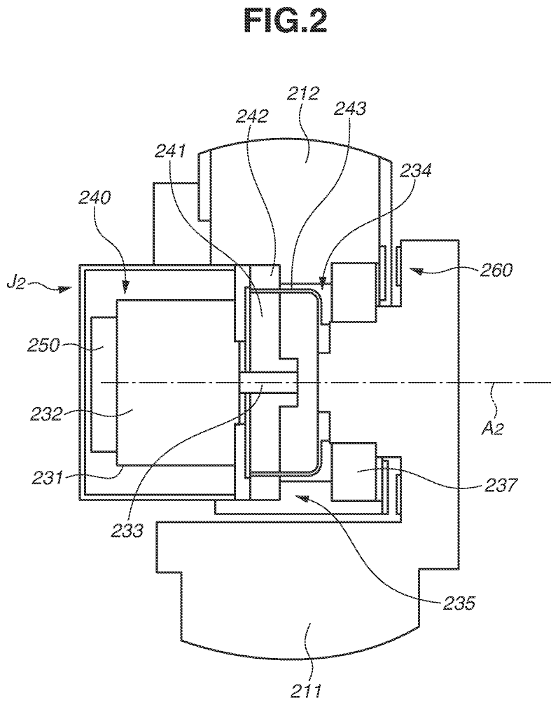

FIG. 2 is a partial cross-sectional diagram illustrating the joint J₂ in the robot arm body 200 of the robot system 100 according to the present exemplary embodiment. The joint J₂ will be described below as a representative example. The other joints J₁ and J₃ to J₆ are similar in configuration to the joint J₂, and thus the descriptions thereof will be omitted.

The link 211 and the link 212 are coupled rotatably through a crossed roller bearing 237. The joint J₂ has a driving mechanism 240. The driving mechanism 240 rotary-drives the link 212 relative to the link 211.

The driving mechanism 240 includes a motor 231 being an example of a driving source and a transmission mechanism 235 that transmits a driving force of the motor 231 to an output side. In the present exemplary embodiment, the transmission mechanism 235 includes a reduction gear 234.

The motor 231 is a servo motor and is, for example, a brushless direct current (DC) motor or an alternating current (AC) motor. The motor 231 includes a housing 232 fixed to the link 212, and a stator and a rotor (not illustrated) that are housed in the housing 232. The stator (not illustrated) is fixed inside the housing 232. The rotor (not illustrated) has a rotary shaft 233 fixed to the rotor. The motor 231 is provided with an input-shaft encoder 250 that detects an angle of rotation of the rotary shaft 233.

For output, the reduction gear 234 decelerates rotation of the rotary shaft 233. The reduction gear 234 has gears and is a strain wave reduction gear in the present exemplary embodiment. The reduction gear 234 being a strain wave reduction gear includes a wave generator 241 being an example of an input shaft and coupled to the rotary shaft 233 of the motor 231, and a circular spline 242 being an example of an output shaft and fixed to the link 212.

The reduction gear 234 also includes a flex spline 243 fixed to the link 211 and arranged between the wave generator 241 and the circular spline 242. The circular spline 242 rotates relative to the wave generator 241 and the flex spline 243 at a speed of rotation decelerated at a predetermined reduction ratio to the speed of rotation of the wave generator 241. In other words, the reduction gear 234 rotates the circular spline 242 at a speed of rotation decelerated at a predetermined reduction ratio to a speed of rotation of the rotary shaft 233 of the motor 231, to rotate the link 212 about a rotational axis A₂, relative to the link 211.

The case where the transmission mechanism 235 includes the reduction gear 234 has been described, but this is not a limitation. For example, the transmission mechanism 235 may include a gear mechanism or belt mechanism provided on an input side or output side of the reduction gear 234.

The second joint J₂ has an output-shaft encoder 260 that detects a relative angle of rotation of the link 212 to the link 211, namely, a joint angle. The output-shaft encoder 260 is arranged on an output side of the transmission mechanism 235, i.e., on the output side of the reduction gear 234. The circular spline 242 being the output shaft of the reduction gear 234 rotates together with the link 212. Thus, the output-shaft encoder 260 detects an angle of rotation of the output shaft of the transmission mechanism 235, i.e., an angle of rotation of the output shaft of the reduction gear 234.

Inside the base 209 of FIG. 1, a servo control unit 230 that drives and controls respective motors 231 of the joints J₁ to J₆. The servo control unit 230 is arranged inside the base 209, but this is not a limitation. For example, the servo control unit 230 may be arranged inside a casing of the control apparatus 400. On the basis of respective command values corresponding to the joints J₁ to J₆ acquired from the control apparatus 400, the servo control unit 230 drives and controls the respective motors 231 of the joints J₁ to J₆ so that the angle of the input shaft or output shaft of the transmission mechanism 235 of each of the joints J₁ to J₆ follows the corresponding command value.

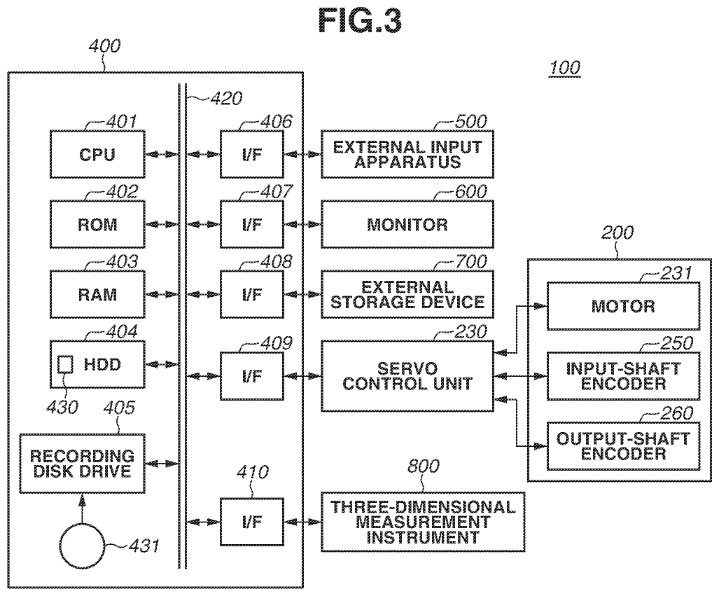

Next, the control apparatus 400 will be described. FIG. 3 is a block diagram illustrating a control system of the robot system 100 according to the present exemplary embodiment. The control apparatus 400 is implemented by a computer and includes a central processing unit (CPU) 401 as an example of a control unit (processing unit).

The control apparatus 400 further includes, as storage units, a read only memory (ROM) 402, a random access memory (RAM) 403, and a hard disk drive (HDD) 404. The control apparatus 400 further includes a recording disk drive 405 and a plurality of interfaces (I/Fs) 406 to 410.

The CPU 401 is connected with the ROM 402, the RAM 403, the HDD 404, the recording disk drive 405, and the I/Fs 406 to 410 via a bus 420.

The ROM 402 stores a basic program, such as a basic input/output system (BIOS). The RAM 403 is a storage device that temporarily stores various types of data, such as a result of arithmetic processing of the CPU 401.

The HDD 404 is a storage device that stores, for example, a result of arithmetic processing of the CPU 401 or various types of data acquired from outside. The HDD 404 records a program 430 for causing the CPU 401 to execute arithmetic processing. On the basis of the program 430 recorded (stored) in the HDD 404, the CPU 401 executes each piece of processing in a control method to be described below, namely, each piece of processing in a method of manufacturing an article. The recording disk drive 405 can read, for example, various types of data or a program recorded in a recording disk 431.

The interface 406 is connected with the external input apparatus 500. The CPU 401 acquires teaching data from the external input apparatus 500 via the interface 406 and the bus 420. The interface 407 is connected with a monitor 600. Under control of the CPU 401, the monitor 600 displays various types of images. The interface 408 is configured to be connectable with an external storage device 700 being a storage unit such as a rewritable nonvolatile memory or an external HDD.

The servo control unit 230 is connected to the interface 409. The servo control unit 230 is communicably connected with the motor 231, the input-shaft encoder 250, and the output-shaft encoder 260 of each of the joints J₁ to J₆ in the robot arm body 200. FIG. 3 illustrates the motor 231, the input-shaft encoder 250, and the output-shaft encoder 260 of one of the plurality of joints J₁ to J₆.

The servo control unit 230 can feedback-control the motor 231 by semi-closed loop control with the input-shaft encoder 250 or full-closed loop control with the output-shaft encoder 260. The CPU 401 can acquire angular information indicating a detection result from each of the input-shaft encoder 250 and the output-shaft encoder 260 via the servo control unit 230, the interface 409, and the bus 420. The CPU 401 outputs data of respective command values corresponding to the joints J₁ to J₆ to the servo control unit 230 via the bus 420 and the interface 409 at predetermined time intervals.

The HDD 404 is a non-transitory computer-readable recording medium. In the present exemplary embodiment, the HDD 404 stores the program 430, but this is not a limitation. The program 430 may be recorded in any non-transitory computer-readable recording medium. Examples of the recording medium for providing the program 430 include a flexible disk, a hard disk, an optical disc, a magneto-optical disk, a magnetic tape, and a nonvolatile memory. Examples of the optical disc include a digital versatile disc read only memory (DVD-ROM), a compact disc read only memory (CD-ROM), and a compact disc recordable (CD-R). Examples of the nonvolatile memory include a universal serial bus (USB) memory, a memory card, and a ROM.

The CPU 401 in the control apparatus 400 executes the program 430 to execute positional control of controlling the position and posture of the leading end of the robot arm body 200, i.e., the position and posture of the end effector body 300, based on trajectory data. For example, the trajectory data is stored in advance in the HDD 404.

In the present exemplary embodiment, two modes for positional control are provided. One of the two modes is a first mode in which the CPU 401 outputs an angular command value for the input shaft of the transmission mechanism 235 to the servo control unit 230 and then the semi-closed loop control is executed by the servo control unit 230 and the input-shaft encoder 250. The other of the two modes is a second mode in which the CPU 401 outputs an angular command value for the output shaft of the transmission mechanism 235 to the servo control unit 230 and then the full-closed loop control is executed by the servo control unit 230 and the output-shaft encoder 260.

The semi-closed loop control is superior in responsivity to the full-closed loop control and thus enables the robot arm body 200 to operate at high speed. The full-closed loop control feeds back the position of the link that is the drive target, enabling highly accurate control.

A case where the CPU 401 executes positional control to the robot arm body 200 in the first mode will be described below. More specifically, the CPU 401 executes the first mode in which the positional control is executed to the robot arm body 200 on the basis of information on the angle of rotation of the input shaft of the transmission mechanism 235 acquired from the input-shaft encoder 250 of each of the plurality of joints ii to J₆ in the robot arm body 200. In the present exemplary embodiment, a case is described where the CPU 401 can selectively execute the first mode or the second mode, but this is not a limitation. The CPU 401 may be able to execute only the first mode with no second mode, or may be able to execute only the second mode with no first mode.

Next, an angular transmission error, an assembly error, and a link parameter in the present exemplary embodiment will be described.

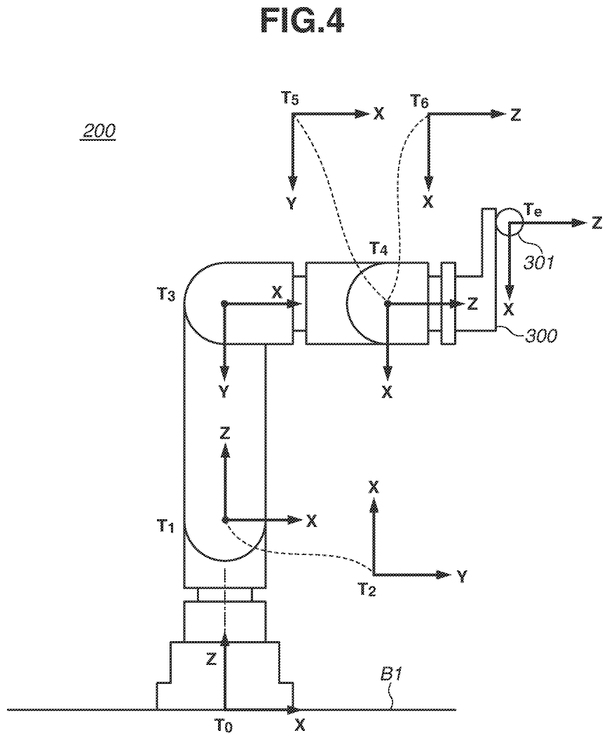

FIG. 4 is a schematic diagram illustrating coordinate systems set to the robot arm body 200 according to the present exemplary embodiment. Coordinate systems T₁ to T₆ illustrated in FIG. 4 are set to the joints J₁ to J₆, respectively. Similarly to the coordinate systems T₀ and Tₑ, the coordinate systems T₁ to T₆ are each expressed by three axes of XYZ. The coordinate systems T₂, T₅, and T₆ are each located on the far side or near side of the plane of the drawing, but are indicated with broken lines for the sake of convenience of the drawing.

In the present exemplary embodiment, the angular transmission error in the reduction gear 234 of each of the joints J₁ to J₆ is calculated by the following Expression (1).

[Mathematical Expression 1]

a sin(bθ+c) (1)

In Expression (1), a represents the amplitude [rad] of the angular transmission error. In Expression (1), b represents the spatial frequency [1/rad] of the angular transmission error. In Expression (1), c represents the initial phase [rad] of the angular transmission error. In Expression (1), θ represents the angle of rotation [rad] of the input shaft (rotary shaft 233) of the reduction gear 234. The amplitude a of the angular transmission error and the initial phase c of the angular transmission error are unknown parameters. The frequency b of the angular transmission error is a value easily determinable from a mechanism of the reduction gear 234 and is a known parameter.

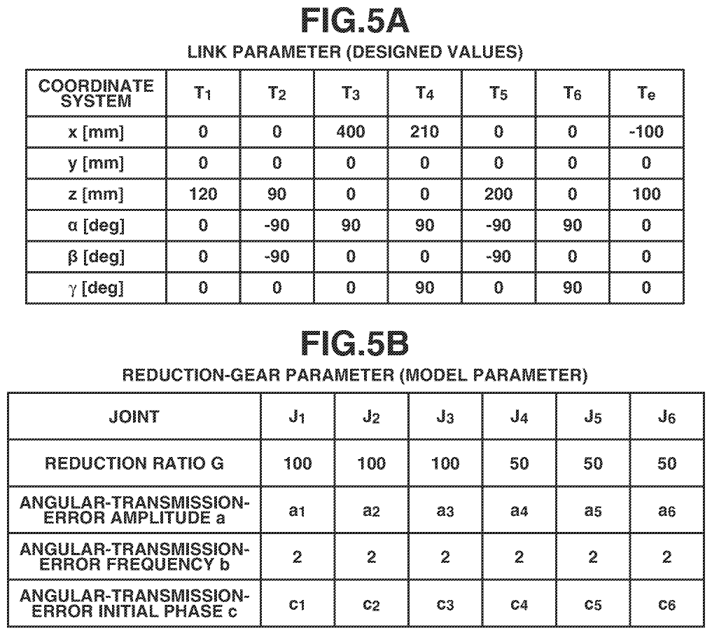

FIGS. 5A and 5B are, respectively, a table for a link parameter in the robot arm body 200 and a table for a reduction-gear parameter in the robot arm body 200 according to the present exemplary embodiment. FIG. 5A indicates the link parameter (designed values) before calibration according to the present exemplary embodiment. In FIG. 5A, x [mm], y [mm], and z [mm] represent offset amounts in the translational directions of the X, Y. and Z axes of each of the coordinate systems T₁ to T₆ and Tₑ relative to the axes (primary axes) of the coordinate system T₀. In FIG. 5A, α [deg], β [deg], and γ [deg] represent offset amounts in the directions of rotation around the Z, Y, and X axes to the axes (primary axes) of the coordinate system T₀ being the reference position. Here, α [deg], β [deg], and γ [deg] are each expressed by circular measure.

FIG. 5B indicates the reduction-gear parameter for the reduction gear 234 of each of the joints J₁ to J₆ in the robot arm body 200. FIG. 5B indicates an example of each model parameter for the reduction ratio G, amplitude a [rad] of the angular transmission error, frequency b [I/rad] of the angular transmission error, and initial phase c [rad] of the angular transmission error of the reduction gear 234 of each of the joints J₁ to J₆. The amplitude a of the angular transmission error and the initial phase c of the angular transmission error are each an unknown parameter varying between the individual reduction gears. Amplitudes a₁ to a₆ of the angular transmission errors and initial phases c₁ to c₆ of the angular transmission errors are allocated to the joints J₁ to J₆, respectively.

In the present exemplary embodiment, a kinematic position x_{FK} as a calculation value of the coordinate system Tₑ of the robot arm body 200 is calculated by the following Expression (2).

$$[ Mathematical Expression 2 ] \\ {x}_{FK} ( {p}_{r} , {p}_{a} , θ ) := {f}_{FK} ( {p}_{r} , q ( θ ) + e ( {p}_{a} , θ ) ) \qquad ( 2 )$$

In Expression (2), pᵣ represents the link parameter in each of the coordinate systems T₁ to T₀ and Tₑ in the robot arm body 200, and corresponds to 42 parameters indicated in FIG. 5A. In Expression (2), pₐ represents the reduction-gear parameter regarding the angular transmission error in the reduction gear 234, and corresponds to 18 parameters indicated in FIG. 5B.

In Expression (2), q results from the angle of rotation θ of the input shaft (rotary shaft 233) of the reduction gear 234, multiplied by the reduction ratio G of the reduction gear 234, and represents a six-dimensional vector indicating the theoretical value of the angle of rotation [rad] of the output shaft (circular spline 242 and driven link) of the reduction gear 234.

In Expression (2), e represents a function that returns, as a sixth-dimensional vector, the angular transmission error [rad] calculated by Expression (1), on the basis of the reduction-gear parameter pₐ regarding the angular transmission error in the reduction gear 234 as a first argument and the angle of rotation θ of the input shaft of the reduction gear 234 as an second argument.

In Expression (2), f_{FK} represents a function that returns, as a three-dimensional vector, the kinematic three-dimensional position [m] of the coordinate system Tₑ in the robot arm body 200. The kinematic three-dimensional position of the coordinate system Tₑ in the robot arm body 200 is calculated by forward kinematics, on the basis of the link parameter pᵣ for the robot arm body 200 as the first argument and the angle of rotation θ of the input shaft of the reduction gear 234 as the second argument.

As described above, in the present exemplary embodiment, the kinematic three-dimensional position of the coordinate system Tₑ in the robot arm body 200 is acquired by calculation with the link parameter pᵣ and the reduction-gear parameter pₐ regarding the angular transmission error, taken into account.

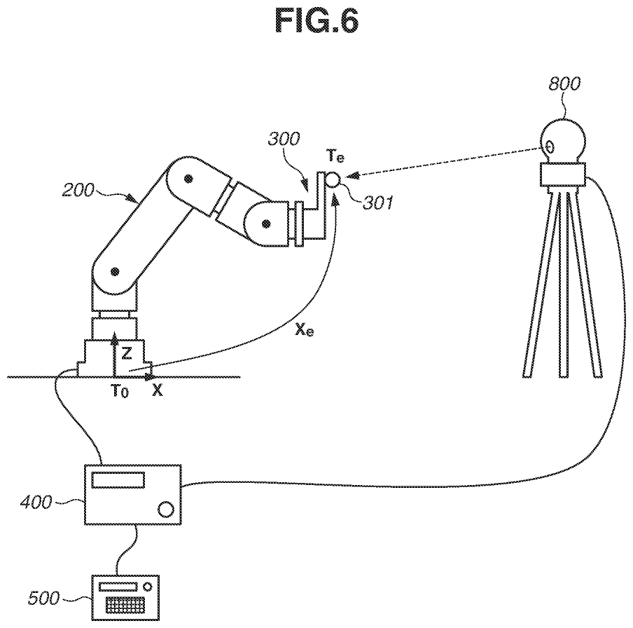

FIG. 6 is a schematic diagram illustrating a measurement system enabling measurement of the position of the end effector body 300 for calibration of the robot arm body 200 according to the present exemplary embodiment. In the present exemplary embodiment, a three-dimensional measurement instrument 800 measures the three-dimensional position of the retroreflector 301 provided at the leading end of the robot arm body 200, i.e., the position of the coordinate system Tₑ in the robot arm body 200. The three-dimensional measurement instrument 800 is a laser tracker, and detects the laser beam reflected from the retroreflector 301 to measure the three-dimensional position of the retroreflector 301. The three-dimensional measurement instrument 800 is already calibrated and can acquire the position of the coordinate system Tₑ as a three-dimensional position xc viewed from the coordinate system T₀.

Data on the three-dimensional position (xₑ) of the coordinate system Tₑ measured by the three-dimensional measurement instrument 800 is stored in the RAM 403 via the interface 410 and the bus 420 in the control apparatus 400. The laser tracker is used as a three-dimensional position measurement apparatus for the coordinate system Tₑ in the present exemplary embodiment, but this is not a limitation. For example, a contact arm-type three-dimensional measurement instrument or a maker-tracking three-dimensional measurement apparatus with a plurality of cameras. In the present exemplary embodiment, such data as above is stored in the RAM 403 in the control apparatus 400, but may be stored in an external storage device.

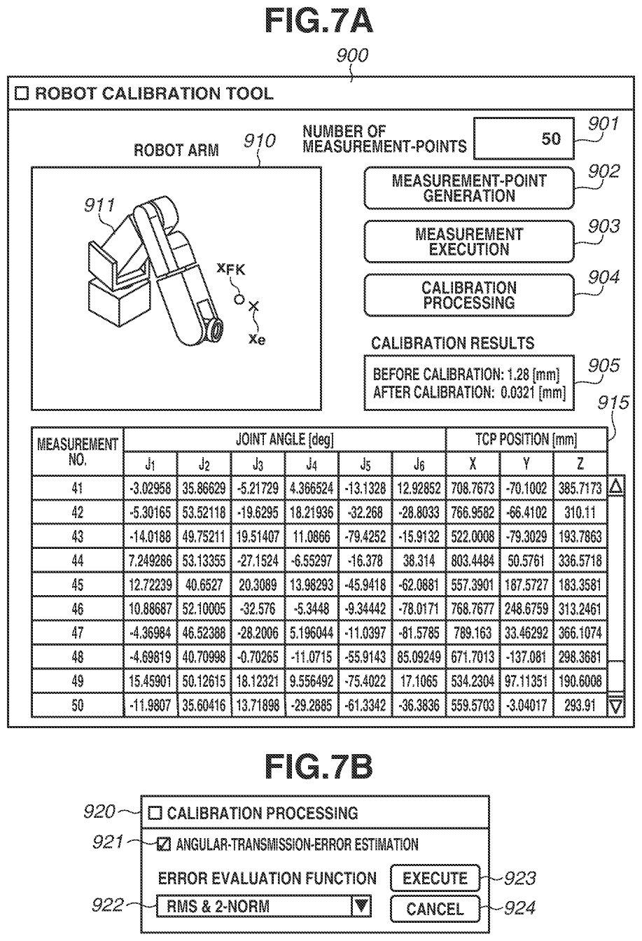

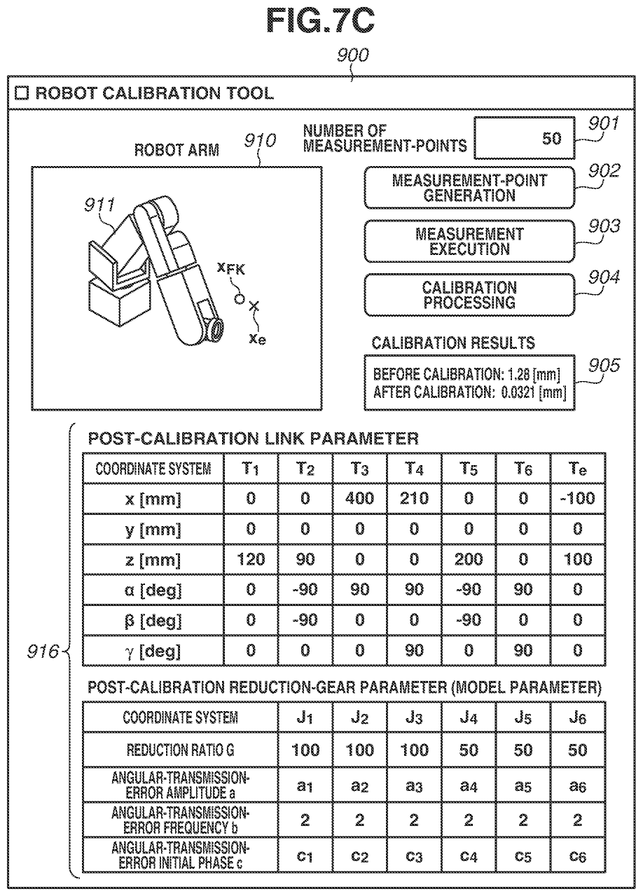

FIGS. 7A to 7C are diagrams each illustrating a calibration user interface according to the present exemplary embodiment. A screen of the calibration user interface is output to the monitor 600 of the control apparatus 400. For example, a user presses a button or inputs a numerical value via the external input apparatus 500. The CPU 401 executes calculation processing involved in output of a calibration tool 900.

FIG. 7A illustrates a main operation screen in the calibration tool 900 of the calibration user interface according to the present exemplary embodiment. FIG. 7B illustrates a calibration processing execution dialogue 920 of the calibration user interface according to the present exemplary embodiment. FIG. 7C illustrates a post-calibration parameter display section 916 displayed according to the present exemplary embodiment.

Referring to FIG. 7A, a number-of-measurement-points input section 901 is a numerical-value input section to which the user inputs a positive integer for a predetermined number-of-measurement-points Nt necessary for calibration of the robot arm body 200. For example, in a case where a numerical value different from any positive integers is input as a predetermined condition, a display prompting the user to make a correction is output on the screen. Alternatively, numerical value previously set as the default value may be input in the number-of-measurement-points input section 901.

A measurement-point generation button 902 is a button-type input interface that starts, in response to a press, processing of generating a measurement point Pt necessary for calibration of the robot arm body 200. The measurement-point generation button 902 is inactive during processing of generating a measurement point, and a press thereon is disabled. The measurement-point generation button 902 is provided so that measurement and calibration can be executed after the user examines the appropriateness of the generated measurement point, as described below.

A measurement execution button 903 is a button-type input interface that starts, in response to a press, measurement of the angle of rotation (joint angle) q of each of the joints J₁ to J₆ and the three-dimensional position xₑ of the coordinate system Tₑ at the position and posture at each measurement point Pt of the robot arm body 200. The measurement execution button 903 is inactive in a case where no measurement point is generated, during execution of measurement, or during robot calibration, and a press thereon is disabled.

A robot-arm display section 910 renders and outputs a three-dimensional model 911 of the robot arm body 200 for each measurement point. The rendering of the three-dimensional model 911 is updated for each measurement point to the real robot arm body 200. The kinematic position x_{FK} of the coordinate system T_{C} in the robot arm body 200 at the measurement point Pt is overlay-displayed as “O” on the robot-arm display section 910, and the three-dimensional position xₑ measured by the three-dimensional measurement instrument 800 is overlay-displayed as “x” on the robot-arm display section 910.

A measurement-result display section 915 outputs, for each measurement point, as numerical values, the joint angle q of each of the joints J₁ to J₆ in the robot arm body 200 and the three-dimensional position xₑ of the coordinate system Tₑ in the robot arm body 200. While verifying such information as above, the user can evaluate the appropriateness of measurement results.

Referring to FIG. 7B, the calibration processing execution dialogue 920 is displayed, in response to a press on a calibration processing setting button 904 of FIG. 7A, at a predetermined position on the monitor 600 together with the calibration tool 900 on the monitor 600. During display of the calibration processing execution dialogue 920, no input is allowed to the main operation screen of the calibration tool 900.

An angular-transmission-error estimation check box 921 is a selective interface enabling selection of whether to execute processing including estimation of the model parameter (reduction-gear parameter) regarding the angular transmission error in calibration processing of the robot arm body 200.

An error-evaluation-function selection pulldown menu 922 is a selective interface (selection section) enabling, from a predetermined set of functions, selection of a function for use in evaluation of the positional error of the coordinate system Tₑ in the robot arm body 200 in calibration processing of the robot arm body 200.

A calibration processing execution button 923 is a button-type input interface that starts calibration processing of the robot arm body 200 in response to a press. During the calibration processing, the calibration processing execution button 923 is inactive, and a press thereon is disabled.

In response to completion of the calibration processing, the calibration processing execution dialogue 920 disappears, and then respective positional error evaluation values of the coordinate system Tₑ before and after calibration are output to a calibration result display section 905 of FIG. 7A. In this case, the output evaluation values correspond to numerical values calculated by the error evaluation function selected from the error-evaluation-function selection pulldown menu 922. In the present exemplary embodiment, the positional error evaluation values are displayed as calibration results, but this is not a limitation.

For example, as in FIG. 7C, in response to a click on the calibration result display section 905, the link parameter after calibration and the reduction-gear parameter after calibration may be displayed as the post-calibration parameter display section 916 instead of the measurement-result display section 915. In FIG. 7C according to the present exemplary embodiment, for simplification of description, the tables of FIGS. 5A and 5B are used as the post-calibration parameter display section 916. However, in practice, the link parameter and the reduction-gear parameter that are calibrated are appropriately displayed.

In response to a press on a calibration processing cancellation button 924 of FIG. 7B, the calibration processing execution dialogue 920 disappears, and the calibration tool 900 becomes active. In the present exemplary embodiment, the calibration processing setting button 904 and the measurement execution button 903 are separately provided so that the user can set, for example, a function for use in calibration processing, but this is not a limitation. For example, in a case where a function is already determined for the calibration processing and calibration is executed so that the angular transmission error is always estimated, measurement and calibration may be executed in response to a single press on the measurement execution button 903.

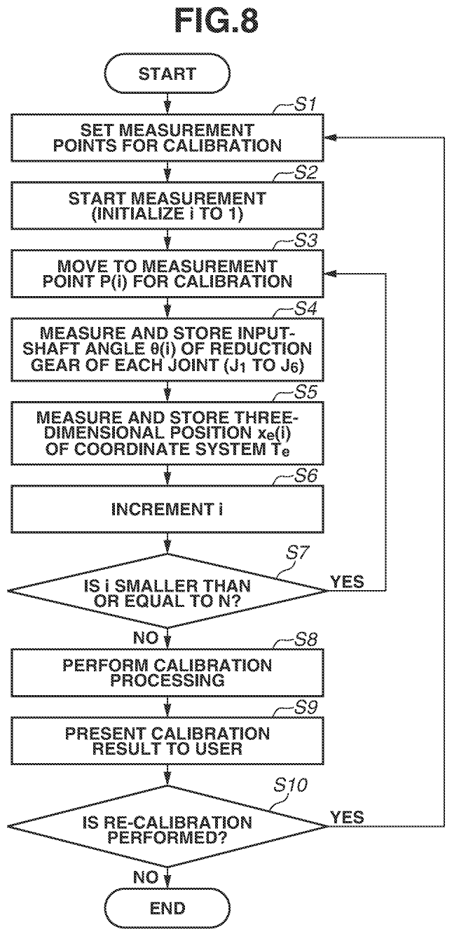

FIG. 8 is a flowchart illustrating a calibration method according to the present exemplary embodiment. The calibration method according to the present exemplary embodiment will be described in detail below with reference to FIGS. 7A to 7C and FIG. 8.

In step S1 of FIG. 8, the user inputs the number-of-measurement-points Nt necessary for calibration to the number-of-measurement-points input section 901 in the calibration tool 900 of FIG. 7A displayed on the monitor 600 and presses the measurement-point generation button 902, to set measurement points for calibration of the robot arm body 200. In the present exemplary embodiment, the number-of-measurement-points Nt is 60. Preferably, the number-of-measurement-points Nt is larger than the total number of parameters to be identified of the link parameter for the robot arm body 2(x) and the reduction-gear parameter regarding the angular transmission error in the reduction gear 234.

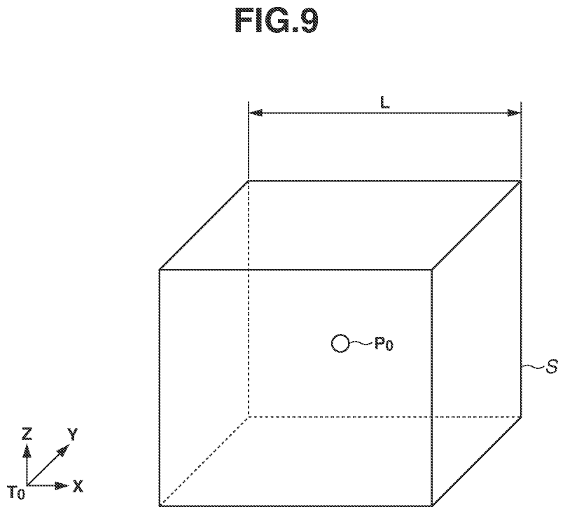

FIG. 9 is a schematic diagram illustrating a measurement-range cube S indicating a setting range of measurement points for calibration of the robot arm body 200 according to the present exemplary embodiment. In the present exemplary embodiment, a length L of each side of the measurement-range cube S is 367 [mm], and the position of the center Po is at 584 [mm] in the X direction. 0 [mm] in the Y direction, and 394 [mm] in the Z direction, on the basis of the coordinate system T₀. Such set information is stored in advance in the HDD 404 or the like, and is read at the time of setting of the measurement points in step S1.

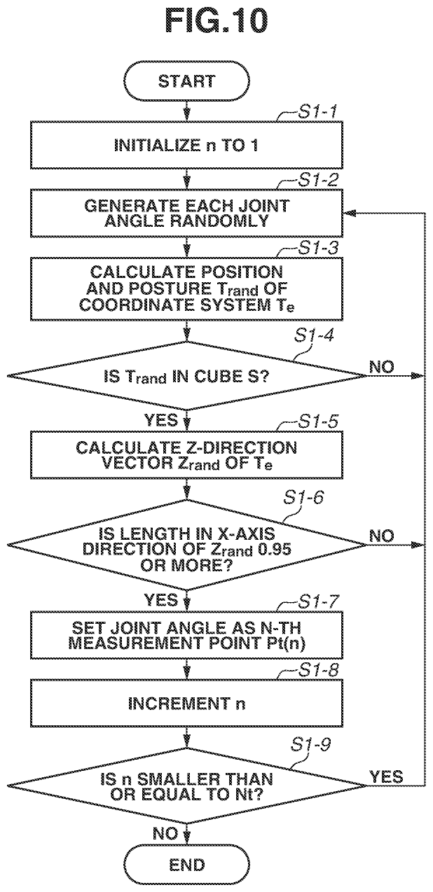

FIG. 10 is a flowchart illustrating setting of the measurement point Pt for calibration of the robot arm body 200 according to the present exemplary embodiment. The CPU 401 generates measurement points Pt the number of which is equal to the number-of-measurement-points set in step S1, in the set measurement-range cube. A method of setting the measurement points Pt, to be executed in step S1, will be described below with reference to the flowchart of FIG. 10.

Referring to FIG. 10, in step S1-1, a variable n for measurement-point counting is initialized to 1.

Next, in step S1-2, the angle of rotation of each of the joints J₁ to J₆ in the robot arm body 200 is randomly generated within predetermined constraint (in a movable range) and then is defined as q_{rand}. In the present exemplary embodiment, the constraint of the joint J₁ is ±90 [deg], the constraint of the joint J₂ is ±45 [deg], the constraint of the joint J₃ is ±45 [deg], the constraint of the joint J₄ is ±90 [deg], the constraint of the joint J₅ is ±90 [deg], and the constraint of the joint J₆ is ±90 [deg].

Next, in step S1-3, a position and posture T_{rand} of the coordinate system Tₑ is calculated by forward kinematics when the angle of rotation of each of the joints J₁ to J₆ in the robot arm body 200 is q_{rand}. The position and posture T_{rand} of the coordinate system Tₑ is a 4×4 homogeneous transformation matrix, and is defined by the following Expression (3).

$$[ Mathematical Expression 3 ] \\ {T}_{rand} = [ \begin{matrix}{R}_{rand} & {x}_{rand} \\ 0 & 1\end{matrix} ] \qquad ( 3 )$$

In Expression (3), x_{rand} represents a three-dimensional vector indicating the position of the coordinate system Tₑ, and Rand represents a 3×3 rotation matrix indicating the posture of the coordinate system Tₑ.

Next, in step S1-4, it is determined whether the position x_{rand} of the coordinate system Tₑ in the robot arm body 200 is in the measurement-range cube S. In a case where the determination result is yes (YES in step S1-4), the processing proceeds to step S1-5. Otherwise (NO in step S1-4), the processing goes back to step S1-2 to re-generate the joint angle.

Next, in step S1-5, a Z-direction vector land of the coordinate system Tₑ is calculated. A rotation matrix R_{rand} of the coordinate system Tₑ is defined by the following Expression (4).

$$[ Mathematical Expression 4 ] \\ {R}_{rand} = [ {X}_{rand} {Y}_{rand} {Z}_{rand} ] \qquad ( 4 )$$

In Expression (4), X_{rand}, Y_{rand}, and Z_{rand} correspond to three-dimensional unit vectors indicating the X-axis, Y-axis, and Z-axis directions viewed from the coordinate system T₀, in the coordinate system Tₑ in the robot arm body 200. The unit vector Z_{rand} corresponds to the Z axis of the coordinate system TT in the robot arm body 200, i.e., the light-receiving direction of the retroreflector 301, and is extracted from the rotation matrix R_{rand} to calculate the Z-direction vector Z_{rand} of the coordinate system Tₑ.

Next, in step S1-6, in a case where the length in the X-axis direction of the unit vector Z_{rand} is 0.95, i.e., in a case where the Z axis of the coordinate system Tₑ in the robot arm body 200 is substantially in the X-axis direction when viewed from the coordinate system T₀ (YES in step S1-6), the processing proceeds to step S1-7. Otherwise (NO in step S1-6), the processing goes back to step S1-2.

In step S1-7, the randomly generated angle of rotation q_{rand} of each of the joints J₁ to J₆ in the robot arm body 200 is stored in the RAM 403 as the n-th measurement point Pt(n).

Next, in step S1-8, the variable n for measurement-point counting is incremented.

Next, in step S1-9, in a case where the variable n for measurement-point counting is smaller than or equal to the number-of-measurement-points Nt set by the user, i.e., smaller than or equal to 60 (YES in step S1-9), the processing goes back to step S1-2. Otherwise (NO in step S1-9), the measurement-point generation processing in step S1 ends.

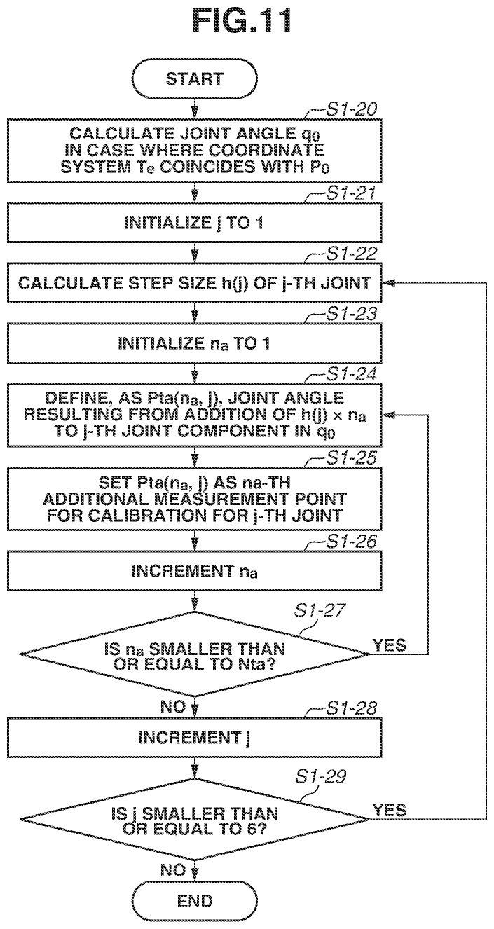

Next, a method of setting an additional measurement point Pta will be described with reference to the flowchart of FIG. 11. The additional measurement point Pta is added for more accurate identification of the reduction-gear parameter pₐ regarding the angular transmission error in each of the joints J₁ to J₆ in the robot arm body 200.

After the processing from step S1-1 to step S1-9, the processing proceeds to step S1-20 of FIG. 11. In step S1-20, the angle of rotation of each of the joints J₁ to J₆ in a case where the coordinate system Tₑ in the robot arm body 200 coincides with the center Po of the measurement-range cube S is calculated by inverse kinematics, and then is defined as a criterial angle q₀. In the present exemplary embodiment, 0 [rad], 0.793 [rad], −0.0382 ‘rad’, 0 [rad], −0.754 [rad], and 0 [rad] are acquired in the order from the first joint J₁ to the sixth joint J₆ in angle of rotation.

Next, in step S1-21, a variable j for joint counting is initialized to 1.

Then, in step S1-22, a step size h(j) [rad] of the additional measurement point Pta for the j-th joint is calculated by the following Expression (5).

$$[ Mathematical Expression 5 ] \\ h ( j ) := \frac{2 π}{{b}_{j} {G}_{j} δ} \qquad ( 5 )$$

In Expression (5), bⱼ represents the angular-transmission-error frequency of the reduction gear 234 of the j-th joint, Gⱼ represents the reduction ratio of the reduction gear 234 of the j-th joint, and δ represents the angular-transmission-error period division number. In the present exemplary embodiment, the angular-transmission-error period division number is 2. An angular-transmission-error period division number δ is a set value for determination of how fine the additional measurement point Pta for calibration is to be set to an angular-transmission-error period of the reduction gear 234, and is preferably a real number of 2 or more, on the basis of the sampling theorem.

Then, in step S1-23, a variable nₐ for additional-measurement-point counting is initialized to 1.

Then, in step S1-24, the nₐ-th additional measurement point Pta(nₐ, j) for the j-th joint is calculated by the following Expression (6).

$$[ Mathematical Expression 6 ] \\ {q}_{tmp} \& = {q}_{0} \\ {q}_{tmp , j} \& = {q}_{0 , j} + h ( j ) {n}_{a} \\ Pta ( {n}_{a} , j \text{)\&} = {q}_{tmp} \qquad ( 6 )$$

In Expression (6), qₜₘₚ represents the temporary variable of the joint angle of each of the joints J₁ to J₆ in the robot arm body 200. The criteria angle q₀ is substituted for qₜₘₚ. In Expression (6), q_{0,j} represents the j-th joint component of the criteria angle q₀, and q_{tmp,j} represents the j-th joint component of the temporary variable qₜₘₚ of the joint angle.

Then, in step S1-25, Pta(nₐ, j) calculated in step S1-24 is stored as the nₐ-th additional measurement point for the j-th joint in the RAM 403.

Then, in step S1-26, the variable nₐ for additional-measurement-point counting is incremented.

Then, in step S1-27, in a case where the variable nₐ for additional-measurement-point counting is smaller than or equal to a number-of-additional-measurement-points Nta (YES in step S1-27), the processing goes back to step S1-24. Otherwise (NO in step S1-27), the processing proceeds to step S1-28. In the present exemplary embodiment, Nta is 6. Nta is an integer of 1 or more and is preferably not less than the angular-transmission-error period division number δ.

Then, in step S1-28, the variable j for joint counting is incremented.

Then, in step S1-29, in a case where the variable j for joint counting is smaller than or equal to the number of joints that is 6 in the robot arm body 200, the processing goes back to step S1-22 (YES in step S1-29). Otherwise (NO in step S1-29), the processing ends. Whether the setting of the additional measurement point described in FIG. 11 is to be executed may be determined based on calibration results.

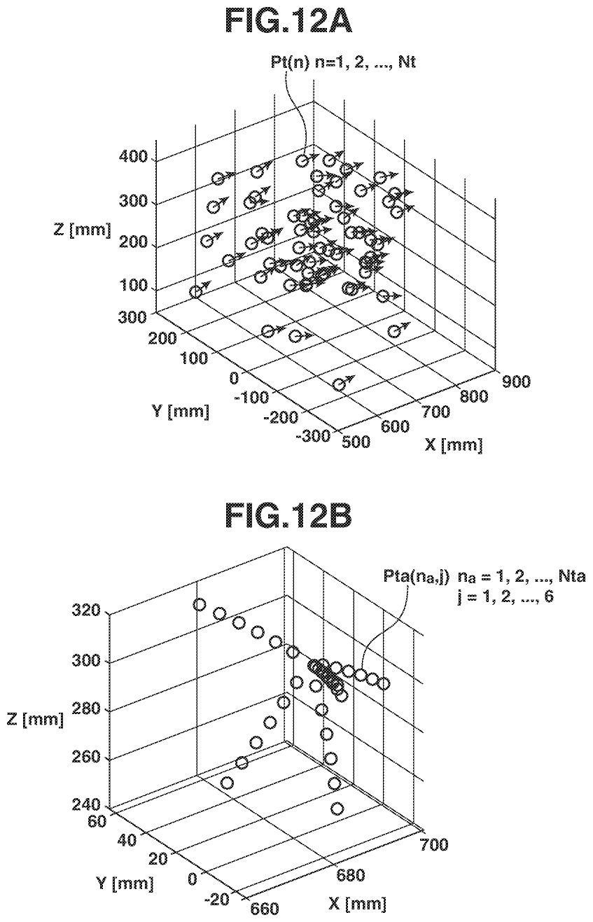

FIG. 12A is a three-dimensional scatter diagram of measurement points generated by the setting of the measurement point described in FIG. 10. FIG. 12B is a three-dimensional scatter diagram of additional measurement points generated by the setting of the additional measurement point described in FIG. 11. In FIG. 12A, each generated measurement point is indicated with O. In FIG. 12B, each generated additional measurement point is indicated with O.

Referring to FIG. 12A, an arrow extending from O representing each measurement point indicates the Z-axis direction of the coordinate system Tₑ at the measurement point. It can be found that the arrow is substantially in the X-axis direction of the coordinate system T₀, i.e., is substantially directed to a position where the three-dimensional measurement instrument 800 is placed. Thus, at each measurement point, the retroreflector 301 can be easily measured by the three-dimensional measurement instrument 800.

Referring to FIG. 12B, data of the measurement point Pt and data of the additional measurement point Pta are combined, resulting in a measurement point P for calibration. A number-of-measurement-points N for calibration for the measurement point P for calibration is calculated by the following Expression (7).

$$[ Mathematical Expression 7 ] \\ N = Nt + Nta \times 6 \qquad ( 7 )$$

As above, setting the number of measurement points by the user enables automatic generation of the necessary number of measurement points suitable for calibration of the robot arm body 200.

Referring back to the flowchart of FIG. 8, the processing from step S2 will be described in detail.

In step S2, the user presses the measurement execution button 903 in the calibration tool 900 to start measurement for calibration of the robot arm body 200. In this case, a variable i for measurement counting is initialized to 1.

Then, in step S3, the CPU 401 executes positional control of the robot arm body 200 in the first mode to drive each of the motors 231 so that the angle of rotation of each of the joints J₁ to J₆ coincides with the angle of rotation set to the i-th measurement point P(i) for calibration.

Then, in step S4, the angle of rotation θ(i) of the input shaft of the reduction gear 234 of each of the joints J₁ to J₆ in the robot arm body 200 is measured by the input-shaft encoder 250 and then is stored in the RAM 403.

Then, in step S5, the three-dimensional position xₑ(i) of the coordinate system Tₑ in the robot arm body 200 is measured with the retroreflector 301 and the three-dimensional measurement instrument 800, and then is stored in the RAM 403.

Then, in step S6, the variable i for measurement counting is incremented. In this case, the CPU 401 updates the rendering of the three-dimensional model 911 of the robot arm body 200 at the time of the i-th measurement, on the robot-arm display section 910. For each measurement point for calibration, the joint angle q(i) of each of the joints J₁ to J₆ in the robot arm body 200 and the three-dimensional position xₑ(i) of the coordinate system Tₑ in the robot arm body 200 are output as numerical values to the measurement-result display section 915. Here, the following equation is satisfied: q(i)=G(i)ₓ θ(i).

Then, in step S7, in a case where the variable i for measurement counting is smaller than or equal to the number-of-measurement-points N for calibration (YES in step S7), the processing goes back to step S3. Otherwise (NO in step S7), the processing proceeds to step S8.

Then, in step S8, in response to a press on the calibration processing setting button 904 by the user, the CPU 401 displays the calibration processing execution dialogue 920 on the monitor 600. Then, the user selects whether to execute angular-transmission-error estimation and selects an error evaluation function for calibration. In the present exemplary embodiment, the angular-transmission-error estimation is enabled, and the error evaluation function is the root mean square (RMS) and 2-norm.

In response to a press on the calibration processing execution button 923 in the calibration processing execution dialogue 920 by the user, the CPU 401 solves a minimization problem expressed by the following Expression (8). More specifically, a link parameter estimate Nest for the robot arm body 200 and a model parameter estimate p_{a,est} regarding the angular transmission error in the reduction gear 234 that minimize an error evaluation function V in Expression (8) are calculated. As a solution for the minimization problem, an interior point method known as a nonlinear optimization algorithm is used.

$$[ Mathematical Expression 8 ] \\ \& min . \& V ( {x}_{e} - {x}_{FK} ( {p}_{r , est} , {p}_{a , est} , θ ) ) \\ \& s . t . = \& {p}_{r , min} < {p}_{r , est ,} {p}_{r , max} \\ \text{\&\&} {p}_{a , min} < {p}_{a , est} < {p}_{a , max} \qquad ( 8 )$$

Pᵣ, min and P_{r,max} in Expression (8) represent, respectively, the minimum value and maximum value of the constraint of the link parameter estimate p_{r,est} for the robot arm body 200. The user designates P_{r,min} and P_{r,max}.

In the present exemplary embodiment, P_{r,min} and P_{r,max} have, respectively, an offset value of −2 [mm] and an offset value of +2 [mm] to a designed value pᵣ in terms of translation components of xyz, and have, respectively, an offset value of −2 [deg] and an offset value of +2 [deg] to the designed value Pᵣ in terms of rotation components of αβγ.

In Expression (8), Pₐ, min and P_{a,max} represent, respectively, the minimum value and maximum value of the constraint of a reduction-gear parameter estimate p_{a,est} regarding the angular transmission error in the reduction gear 234 of each of the joints J₁ to J₆ in the robot arm body 200. The user designates P_{a,min} and P_{a,max}. In the present exemplary embodiment, the reduction-gear parameter P_{a,min} has an amplitude of 0 [rad] and a phase of −π/2 [rad], and the reduction-gear parameter P_{a,max} has an amplitude of 0.001 [rad] and a phase of π/2 [rad].

The error evaluation function V results from selection by the user via the calibration processing execution dialogue 920. The error evaluation function V is an evaluation function for a three-dimensional positional error E of the coordinate system Tₑ in the robot arm body 200, and is expressed, in the present exemplary embodiment, by the following Expression (9). PGP-25,E [Mathematical Expression 9]

$$[ Mathematical Expression 9 ] \\ V ( E ) := \sqrt{\frac{1}{N} {\sum }_{k = 1}^{3} {\sum }_{i = 1}^{N} {E}_{ik}^{2}} \qquad ( 9 )$$

In Expression (9), Eᵢₖ represents the k-th component of the i-th three-dimensional positional error of the coordinate system Tₑ in the robot arm body 200. More specifically, the error evaluation function V according to the present exemplary embodiment calculates the RMS value of all measurement points of the three-dimensional positional error of the coordinate system Tₑ and further calculates the 2-norm of all the components of xyz thereof.

The error evaluation function V is not limited to the function expressed by Expression (9). Thus, the error evaluation function V may be, for example, a function that evaluates the maximum value of the absolute value of an input value or a function that evaluates the peak-to-peak (PP) value of an input value.

Then, in step S9, in response to completion of calibration processing on the robot arm body 200, the CPU 401 outputs, to the calibration result display section 905, the error evaluation values before and after calibration, i.e., the numerical values expressed by the following Expressions (10) and (11). In Expression (10), pₐ₀ represents the initial value of the model parameter regarding the angular transmission error in the reduction gear 234, and all components thereof are zero in the present exemplary embodiment.

$$\begin{matrix}\begin{matrix}[ Mathematical Expression 10 ] \\ V ( {x}_{e} - {x}_{FK} ( {p}_{r} , {p}_{a} , θ ) & \end{matrix} & ( 10 ) \\ \begin{matrix}[ Mathematical Expression 11 ] \\ V ( {x}_{e} - {x}_{FK} ( {p}_{r , est} , {p}_{a , est} , θ ) & \end{matrix} & ( 11 )\end{matrix}$$

Then, in step S10, the user verifies the error evaluation values before and after calibration that are output on the calibration result display section 905, and determines whether to execute re-calibration. In a case where the re-calibration is performed (YES in step S10), the processing goes back to step S-1. Otherwise (NO in step S10), the calibration ends. For display of error evaluation values on the calibration result display section 905, the error evaluation values before and after calibration at a teaching point in the work set in advance by the user may be displayed. Thus, an evaluation of the calibration of the work itself that the user desires to execute can be made.

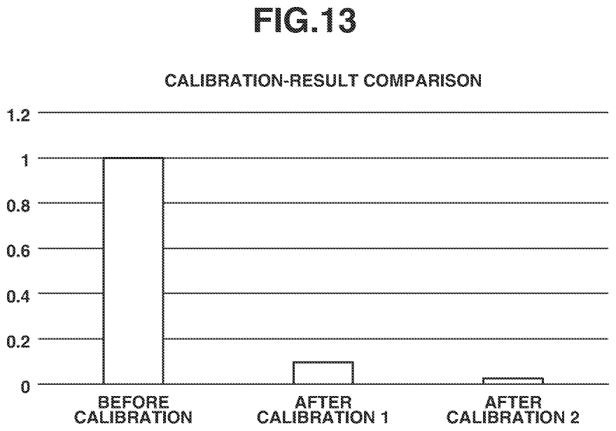

FIG. 13 is a graph illustrating comparison between error evaluation results before and after calibration of the robot arm body 200 according to the present exemplary embodiment. In a case where the evaluation value before calibration is defined as 1 for comparison, the evaluation value after calibration 1 and the evaluation value after calibration 2 are 0.096 and 0.025, respectively. The evaluation value after calibration 1 corresponds to calibration without estimation of the reduction-gear parameter regarding the angular transmission error. The evaluation value after calibration 2 corresponds to calibration with estimation of the reduction-gear parameter regarding the angular transmission error.

Referring to FIG. 13, the three-dimensional positional error E of the coordinate system Tₑ in the robot arm body 200 is improved by approximately 97% due to the calibration with estimation of the reduction-gear parameter regarding the angular transmission error described in the present exemplary embodiment. Furthermore, the three-dimensional positional error E due to the calibration with estimation of the reduction-gear parameter pₐ is improved by 74% in comparison to the three-dimensional positional error E due to the calibration without estimation of the reduction-gear parameter pₐ.

As above, in the present exemplary embodiment, the link parameter Pᵣ and the reduction-gear parameter pₐ regarding the angular transmission error are used in calculation of a calculation value of the position of the coordinate system Tₑ for comparison with an actually measured value of the position of the coordinate system Tₑ in calibration of the robot arm body 200. At the time of measurement of the coordinate system Tₑ, the angle of each joint is detected. Thus, measurement of data necessary for calibration, namely, measurement of each joint angle in the robot arm body 200 and the three-dimensional position of the end effector, and calibration processing are executed in the same measurement system.

In a conventional method, identification of the characteristic of the angular transmission error in a transmission mechanism and calibration for reduction of the positional error in an end effector due to the assembly error in a robot arm are executed in respective different measurement systems. However, in the present exemplary embodiment, the same measurement system and calibration processing enable unified calibration of the link parameter and the reduction-gear parameter, so that highly accurate calibration can be efficiently executed for an effective reduction of the positional error in the end effector due to the assembly error and the angular transmission error. Therefore, the time taken for calibration can be considerably shortened.

Furthermore, as described in FIGS. 7A to 7C, the measurement execution button 903 for measurement of the robot arm body 200 and the calibration processing execution button 923 are displayed. Thus, an operator can easily calibrate the robot arm body 200. Furthermore, display of the measurement-point generation button 902 for automatically setting measurement points enables automatic setting of intricate measurement-point setting, so that the operator can even more easily calibrate the robot arm body 200.

The processing procedure according to the exemplary embodiment described above is specifically implemented by the control apparatus 400. Thus, a recording medium in which a software program capable of implementing the functions described above is recorded is provided to the control apparatus 400, and then the CPU 401 reads and executes the program stored in the recording medium to implement the functions. In this case, the program read from the recording medium implements the functions according to the exemplary embodiment described above, so that the program and the recording medium having the program recorded therein are constituents in the present disclosure. For example, a program that implements one or more functions of the exemplary embodiment described above may be provided to a system or an apparatus via a network or a recording medium, and then one or more processors in a computer in the system or the apparatus read and execute the program to implement the functions. A circuit (e.g., an application-specific integrated circuit (ASIC)) that implements one or more functions may be provided to implement the functions.

In the exemplary embodiment, the HDD 404 serves as a computer-readable recording medium, and the control program is stored in the HDD 404. However, the present disclosure is not limited to such a mode.

The control program according to the exemplary embodiment of the present disclosure may be recorded in any computer-readable recording medium. Examples of the recording medium for providing the control program include an HDD, an external storage device, and a recording disk.

In the exemplary embodiment described above, with the control apparatus 400 and the monitor 600, the calibration tool 900 is displayed and an input from the user is accepted, but this is not a limitation. For example, a personal computer (PC) or an information processing apparatus that includes a CPU and a display apparatus such as a monitor, or an electronic apparatus such as a smartphone or a tablet may be used. In a case where the external input apparatus 500 is a teach pendant including a display apparatus, the display apparatus may display the calibration tool 900.

In the exemplary embodiment, the case where the robot arm body 200 is a vertical articulated robot arm has been described, but this is not a limitation. Any type of robot arm, such as a horizontal articulated robot arm, a parallel link robot arm, or a Cartesian coordinate robot, may be used.

In the exemplary embodiment described above, the robot apparatus is used, but this is not a limitation. For example, as the robot apparatus, a machine capable of automatically performing expansion and contraction, bending and stretching, upward and downward movements, lateral movement, turning, or any combined operation of thereof on the basis of information in a storage device provided in a control apparatus may be used.

The present disclosure is not limited to the exemplary embodiment described above, and thus many alterations can be made without departing from the technical concept of the present disclosure. The effects of the exemplary embodiment are just the most desirable effects of the present disclosure, and thus the effects of the present disclosure are not limited to ones described in the exemplary embodiment.

According to exemplary embodiments of the present disclosure, an operator can easily calibrate the robot apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-196002, filed Nov. 26, 2020, which is hereby incorporated by reference herein in its entirety.

What is claimed is:

1. An information processing apparatus comprising:
one or more processors configured to:
execute measurement of a position of a predetermined part of a robot apparatus including a joint having a transmission mechanism and calibration of the robot apparatus,
wherein the measurement and the calibration are executed in response to a predetermined operation.

2. The information processing apparatus according to claim 1, comprising:
a display unit configured to display a first button for execution of the measurement and a second button for execution of the calibration based on the measurement.

3. The information processing apparatus according to claim 2, wherein the display unit displays a third button for automatic setting of a plurality of positions of the predetermined part as measurement points for execution of the measurement.

4. The information processing apparatus according to claim 3, wherein the measurement points are randomly set in a movable range of the robot apparatus.

5. The information processing apparatus according to claim 3, wherein the display unit displays an input section for setting of a number of the measurement points.

6. The information processing apparatus according to claim 5, wherein the display unit displays, in a case where the number does not satisfy a predetermined condition, a display prompting correction of the number.

7. The information processing apparatus according to claim 2, wherein the display unit displays, as a result of the measurement, the position of the predetermined part as a three-dimensional value and displays, as a result of the measurement, an angle of the joint in a case where the predetermined part is at the position.

8. The information processing apparatus according to claim 2, wherein the display unit displays, as results of the calibration, a first error that occurs in a case where the robot apparatus operates the predetermined part before the calibration and a second error that occurs in a case where the robot apparatus operates the predetermined part after the calibration.

9. The information processing apparatus according to claim 8, wherein the first error and the second error are each an error at a teaching point in a case where the robot apparatus executes predetermined work.

10. The information processing apparatus according to claim 8, wherein the display unit displays a selection section for selection of an evaluation function that evaluates the first error and the second error.

11. The information processing apparatus according to claim 2, wherein the measurement and the calibration are executed in response to a press on the first button.

12. The information processing apparatus according to claim 2, wherein a first parameter regarding design of the robot apparatus and a second parameter regarding a characteristic of the transmission mechanism are calibrated in response to a press on the second button.

13. The information processing apparatus according to claim 12,
wherein, in calibration of the first parameter and the second parameter, a theoretical value of the position of the predetermined part is acquired based on the first parameter and the second parameter, and
wherein the first parameter and the second parameter are calibrated based on the theoretical value and an actually measured value of the position of the predetermined part.

14. The information processing apparatus according to claim 13, wherein, in the calibration of the first parameter and the second parameter, the first parameter and the second parameter are calibrated based on a solution of a minimization problem that minimizes a difference between the theoretical value and the actually measured value.

15. The information processing apparatus according to claim 12, wherein the display unit displays the first parameter and the second parameter that are calibrated.

16. The information processing apparatus according to claim 12,
wherein the first parameter is a link parameter regarding the robot apparatus, and
wherein the second parameter is a parameter regarding a characteristic of an angular transmission error in the transmission mechanism.

17. The information processing apparatus according to claim 16,
wherein a plurality of joints is provided,
wherein the link parameter is a value of a distance of each of the plurality of joints to a reference position, and
wherein the parameter regarding the characteristic of the angular transmission error is an amplitude of the angular transmission error in the transmission mechanism and an initial phase of the angular transmission error.

18. The information processing apparatus according to claim 1, wherein the measurement and the calibration are simultaneously executed in response to the predetermined operation.

19. A robot system comprising:
the information processing apparatus according to claim 1; and
a robot arm provided with an end effector as the robot apparatus.

20. A method of manufacturing an article by using the robot system according to claim 19.

21. A measurement system comprising:
the robot system according to claim 19; and
a measurement apparatus configured to measure a position of the end effector.

22. An information processing method comprising:
executing measurement of a position of a predetermined part of a robot apparatus including a joint having a transmission mechanism and calibration of the robot apparatus,
wherein the measurement and the calibration are executed in response to a predetermined operation.

23. The information processing method according to claim 22, further comprising:
displaying a first button for execution of the measurement and a second button for execution of the calibration of the robot apparatus based on the measurement on a display unit.

24. The information processing method according to claim 23, wherein a first parameter regarding design of the robot apparatus and a second parameter regarding a characteristic of the transmission mechanism are calibrated in response to a press on the second button.

25. The information processing method according to claim 24,
wherein, in calibration of the first parameter and the second parameter, a theoretical value of the position of the predetermined part is acquired based on the first parameter and the second parameter, and
wherein the first parameter and the second parameter are calibrated based on the theoretical value and an actually measured value of the position of the predetermined part.

26. The information processing method according to claim 25, wherein, in the calibration of the first parameter and the second parameter, the first parameter and the second parameter are calibrated based on a solution of a minimization problem that minimizes a difference between the theoretical value and the actually measured value.

27. The information processing method according to claim 24, further comprising:
displaying the first parameter and the second parameter that are calibrated on the display unit.

28. The information processing method according to claim 24,
wherein the first parameter is a link parameter regarding the robot apparatus, and
wherein the second parameter is a parameter regarding a characteristic of an angular transmission error in the transmission mechanism.

29. The information processing method according to claim 28,
wherein a plurality of joints is provided,
wherein the link parameter is a value of a distance of each of the plurality of joints to a reference position, and
wherein the parameter regarding the characteristic of the angular transmission error is an amplitude of the angular transmission error in the transmission mechanism and an initial phase of the angular transmission error.

30. A non-transitory computer-readable recording medium storing a program for causing a computer to execute the information processing method according to claim 22.
